(19) United States
(12) Patent Application Publication
(10) Pub. No.: US 2015/0075124 A1
(43) Pub. Date: Mar. 19, 2015

(54) CYCLONE SEPARATOR

(71) Applicant: MGI COUTIER, Champfromier (FR)

(72) Inventors: Pascal Guerry, Seppois-Le-Haut (FR); Antony Nollevaux, Champfromier (FR); Adrien Eustache, Nantua (FR)

(21) Appl. No.: 14/388,647

(22) PCT Filed: Mar. 21, 2013
(86) PCT No.: PCT/FR2013/050605

§ 371 Date: Sep. 26, 2014

(30) Foreign Application Priority Data
Mar. 26, 2012 (FR) 12/52673

(51) Int. Cl. B01D 45/16

(52) U.S. Cl. CPC B01D 45/16
USPC 55/459.1

(57) ABSTRACT

The separator comprises an outer body of a generally cylindrical shape, having a flat bottom, with an upper tangential gas inlet and an axial gas outlet, in addition to a cylindrical collecting area and a lower storage area for the separated phase. A recessed inner body with rotational symmetry is movably mounted vertically in the outer body, and cooperates with the opening of the upper tangential gas inlet and/or with the start of the axial gas outlet, in such a way as to make the cross section of the gas passage variable according to the height position of the inner body. Application to oil-gas separation, in particular for recovering oil particles contained in the recycled crankcase gases of an internal combustion engine of a motor vehicle.

The present invention relates, generally, to separator devices of the kind of those known under the <<cyclone>> designation, which make the liquid-gas separation of aerosol phases. More particularly, this invention focuses on a cyclone separator, suitable for the oil-gas separation in the field of internal combustion engines, and still more particularly a cyclone separator provided for the separation and the recovery of oil particles contained in the recycled crankcase gases, in an internal combustion engine of motor vehicle.

In a generally known manner, such a cyclone separator comprises, from top to bottom:
a tangential upper inlet of the gases containing oil drops to be eliminated;
a catchment area, in which the oil drops are projected on the wall of the cyclone by the centrifugal force effect, this area being usually cylindrical-shaped;
an area of recovery of the liquid oil, area which is usually cylindrical-shaped;
a lower box forming a storage volume of the collected oil.

The cyclone separator further comprises an upper central opening, through which the gases, freed from their oil, exit.

As examples of conventional cyclone separators, characterized in particular by a recovery area having a conical shape, reference is made to patent documents FR 2 738 758 and EP 0 972 572.

By patent document FR 2 922 126, in the name of the Applicant, there is also known a cyclone separator in which, in order to limit the total height of the device, the conical-shaped area is removed so that the cylindrical-shaped catchment area directly communicates with the lower volume of storage of the collected oil. While reducing the size of the cyclone separator, this design allows increasing the effectiveness thereof (for a given dimension).

For a cyclone separator that maintains a conical-shaped recovery area, the patent document FR 2 924 364, also in the name of the Applicant, proposes an improvement which consists in placing, inside the cylindrical area of catchment and the conical area of recovery of the oil, a vertically movable and possibly rotative body. This inner body, with a cylindro-conical general shape, delimits with the walls of the separator an annular interstice the section of which varies according to the height position of this body, which is itself a function of the gas flow rate. The weight of the cylindro-conical body thus equilibrates with the resultant of the pressure forces applied on this body, so that the velocity of the gas flux and the pressure drops remain substantially constant. We hence obtain, by this mean, a cyclone separator effectiveness which is itself constant, without inducing supplementary pressure drops. In particular, in the application concerned, the passage section varies as a function of the gas flow rate, according to the engine speeds, which allows obtaining a good separation of the oil at low flow rate and limiting the pressure drops at high flow rate.

However, this last technical solution is specific to a cyclone separator with a conical-shaped recovery area, and thus it does not allow reducing the size of the separator.

The present invention aims to improve even more significantly the cyclone separators, by combining the advantages of the separators without the conical area and those of the separators with the variable passage section, while avoiding their respective drawbacks, so as to optimize their operation and their effectiveness at all flow rates, while limiting their size.

To this end, the object of the invention is a cyclone separator, in particular provided for the oil-gas separation and more particularly provided for the separation and the recovery of oil particles contained in the recycled crankcase gases, in an internal combustion engine of a motor vehicle.

the cyclone separator including, from top to bottom: a tangential upper inlet of the gases containing particles and in particular oil drops to be eliminated, a cylindrical area of catchment of the particles and in particular of liquid oil, and a lower area of storage of the phase, such as the oil, which has been separated, while an axial outlet of the gases is provided, the outer body of the cyclone separator having a generally cylindrical shape with a flat bottom, without a conical lower area,

this cyclone separator being essentially characterized by the fact that, in the outer body, is movably mounted vertically a rotationally symmetrical recessed inner body cooperating with the opening of the tangential upper inlet of the gases and/or with the start of the axial outlet of the gases, so as to make the passage section of the gases variable according to the height position of said inner body.

The invention is thus based on the discovery that, even in the case of a cyclone separator devoid of conical lower area, hence externally exhibiting a generally cylindrical shape, it is possible to vary the passage section of the gases, in particular at the inlet and/or at the outlet of these gases.

More precisely, in operation, the vertically movable inner body, under the effect of its own weight and eventually of a spring (as specified below), obturates in a relatively significant way the inlet and/or the outlet of the gases at low flow rates. Conversely, at high flow rates, the gas flux raises the movable inner body thus increasing the passage section of the gases at the inlet and/or at the outlet of the separator, and correlatively reduces the pressure drops. The inner body is thus raised or lowered, so as to maintain an equilibrium position.

Advantageously, the vertically movable inner body has an upper area having a cylindrical general appearance, capable of more or less hiding the opening of the tangential upper inlet of the gases, according to the height position of said inner body.

In the simplest embodiment, the upper area of the vertically movable inner body is extended, downwards, by a tubular portion of this movable inner body which itself constitutes the start of the axial outlet of the gases (with no other particularity at this level).

However, according to a preferred embodiment of the cyclone separator object of the invention, the lower portion of the vertically movable inner body is provided to cooperate with a fixed central element mounted inside the cyclone separator, so as to vary the passage section at the start of the axial outlet of the gases, according to the height position of said inner body. The lower portion of the vertically movable inner body may here, in particular, exhibit a flared shape and cooperate in this case with a fixed central element having a conical or frustoconical appearance. According to the height position of the movable inner body, we thus obtain a variation of the <<air gap>> between the base of this inner body and the top of the fixed central element.

In all cases, spring means are advantageously provided to bias the movable inner body vertically downwards.

The vertically movable inner body being slidably mounted with some functional clearance in the outer body of the cyclone separator, we further advantageously provide at least one gasket placed between the vertically mobile inner body and the outer body of the cyclone separator, so as to avoid the internal short-circuits or leakages.

As a whole, we obtain thanks to the invention a cyclone separator which combines the advantages of the separators devoid of conical area and of the separators with conical area and cylindro-conical movable inner body. Thus, the structure of the cyclone separator object of the invention leads to a small footprint, an increase of its effectiveness at low flow rate and a reduction of pressure drops at high flow rate.

In addition, the flat bottom of this cyclone separator, combined with a suction at a single low point and with a spring which compresses the gas flow, allows having an impaction also in the lower area of the separator, hence a further increased effectiveness in particular at low flow rate, with the same size.

Anyway, the invention will be better understood, and other characteristics and advantages will be highlighted, with the help of the following description and with reference to the appended schematic drawing representing, by way of example, some embodiments of this cyclone separator:

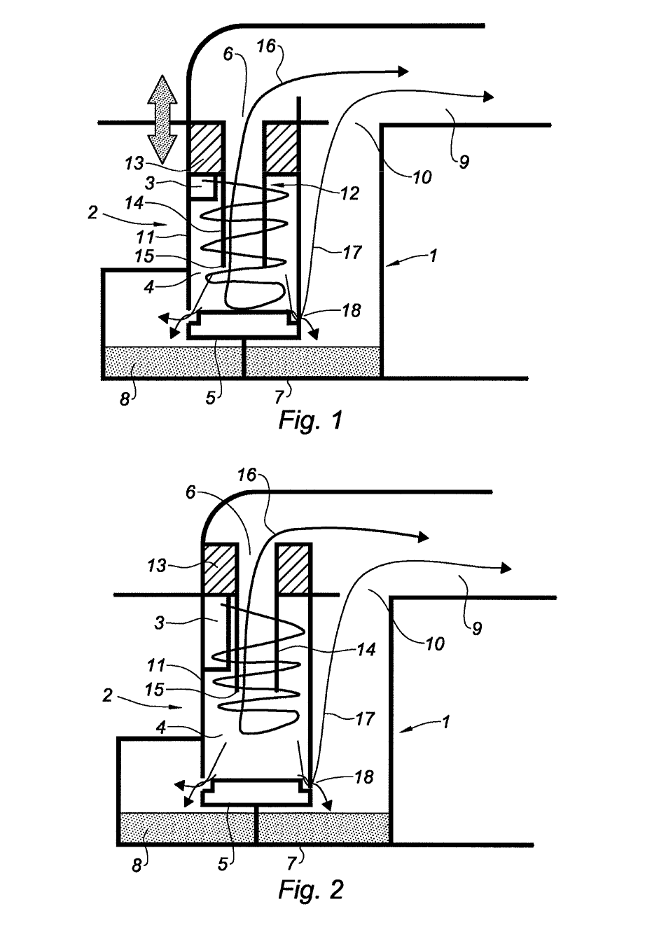

FIG. 1 is a vertical section view of a cyclone separator in accordance with the present invention, in a first embodiment, with the inner body in the low position;

FIG. 2 is a view similar to FIG. 1, but with the inner body in the high position;

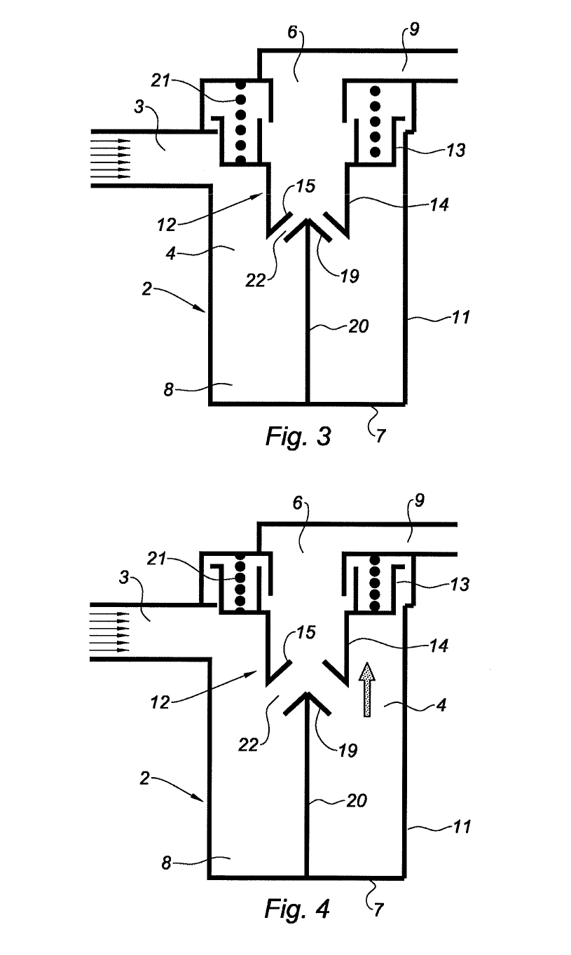

FIG. 3 is a vertical section view of a cyclone separator in accordance with the present invention, in a second embodiment, with the inner body in the low position;

FIG. 4 is a view similar to FIG. 3, but with the inner body in the high position;

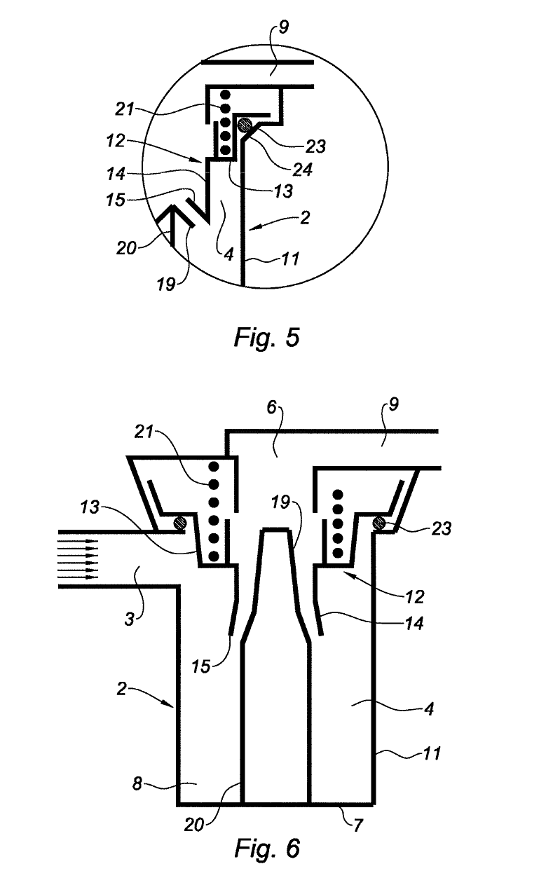

FIG. 5 represents a detail of the gasket mounting, as an alternative of the embodiment of FIGS. 3 and 4;

FIG. 6 is a vertical section view of a cyclone separator in accordance with the present invention, in a third embodiment.

Referring first to FIGS. 1 and 2 which show a first embodiment, a cyclone separator comprises, inside a housing 1, an actual <<cyclone>> portion 2, generally cylindrical-shaped. The cyclone portion 2 includes, from top to bottom: a tangential upper inlet 3 of the gases containing oil to be eliminated, a cylindrical area 4 of catchment of oil drops, and a circular bottom 5. The cyclone portion 2 also includes an upper axial outlet 6 for the gases freed from their oil, while the flat bottom 7 of the housing 1 forms a storage volume 8 for the oil recovered by catchment and stored in liquid phase.

In the upper portion of the cyclone separator extends a horizontal suction duct 9, which prolongs the upper axial outlet 6 of the gases. A communication is realized by a suction hole 10 between the upper portion of the storage volume 8, on one hand, and a point of the suction duct 9, on the other hand.

The cyclone portion 2 of the separator thus has a fixed outer body 11, with a cylindrical-shape and a flat bottom, without a conical lower area. Inside the cylindrical outer body 11 is coaxially mounted a rotationally symmetrical inner body 12, the inner body 12 being vertically movable relative to the outer body 11.

The inner body 12 has an upper area 13 with a cylindrical appearance and a larger diameter. The upper area 13 is prolonged, downwards, by a tubular portion 14 with a smaller diameter, which thus sinks inside the outer body 11, toward the bottom 5. The lower end 15 of the tubular portion 14 constitutes the start point of the axial outlet 6 of the gases.

In operation, the outlet of the cyclone separator <<naturally>> creates a pressure drop, which is enough to create itself a depression in the storage volume 8, via the suction hole 10. This already results in a large effectiveness of the cyclone separator, and also in an absence of oil projections by the upper axial outlet 6 of the gases. It will also be noted that the gases admitted in the cyclone portion 7 by the tangential upper inlet 3 are divided into:
A main flow 16 first descending helically about the tubular portion 14 of the inner body 12, then partially travelling through the cylindrical area 4 of catchment and rising by the inside of the tubular portion 14, to finally escape axially by the axial outlet 6 and evacuate by the suction duct 9;
A secondary flow 17 descending down to the circular bottom 5 of the cyclone portion 2, to escape therefrom by an annular interstice 18 and travel through the storage volume 8, before passing through the suction hole 10 to finally join the suction duct 9 and merge with the main flow 16.

In addition, the vertically movable inner body 12 is involved as follows:

At low gas flow rates, as shown in FIG. 1, the inner body 12 occupies a relatively low equilibrium position, in which its upper area 13 with a larger diameter significantly covers the tangential upper inlet 3 of the gases.

At high flow rates, as shown in FIG. 2, the inner body 12 occupies a relatively high equilibrium position, under the effect of the gas flux. The upper area 13 of the inner body 12 then clears more or less completely the tangential upper inlet 3, hence a reduction of the pressure drop.

FIGS. 3 and 4, in which the elements corresponding to those already described are designated by the same numerals, show a second embodiment.

In this one, the vertically movable inner body 12 includes an upper area 13 with a larger diameter, extended downwards by a tubular portion 14 with a smaller diameter, the lower end 15 of which exhibits a conical shape, like an inverted funnel.

This lower end 15 of the tubular portion 14 surmounts a conical-shaped fixed central element 19, mounted inside the cyclone portion 2 at the top of a central foot 20 itself fixed on the flat bottom 7 of the cyclone portion 2.

Moreover, a helical spring 21, working in compression, is mounted between the top of the cyclone portion 2 and the vertically movable inner body 12. This inner body 12 is thus permanently biased downwards.

Thus, during the operation of the cyclone separator, the annular interstice or <<air gap>> 22, located between the lower end 15 of the tubular portion 14 of the inner body 12, on the one hand, and the fixed central element 19, on the other hand, varies depending on the height position of the inner body 12. The latter hence varies the section of the gases inlet in the cyclone portion 2 as well as the section of the gases outlet.

More particularly, at low gas flow rates, as shown in FIG. 3, the inner body 12 occupies a low equilibrium position, in which:
its upper area 13 with a larger diameter significantly covers the tangential upper inlet 3 of the gases;
the lower end 15 of its tubular portion 14 with a smaller diameter is moved closer to the fixed central element 19, thus limiting the outlet section.

On the contrary, at high flow rates, as shown in FIG. 4, the inner body 12 occupies a high equilibrium position, in which:
its upper area 13 clears more or less completely the tangential upper inlet 3;
the lower end 15 of its tubular portion 14 is moved away from the fixed central element 19, thus increasing the outlet section.

To avoid the internal leakages at low flow rates, a gasket 23, which is in particular an o-ring gasket, is inserted between the vertically movable inner body 12 and the outer body 11. As shown in FIG. 5, the gasket 23 is placed at the upper area 13 of the vertically movable inner body 12. Preferably, this gasket 23 bears on a frustoconical surface 24 of the outer body 11 of the cyclone separator, to avoid the sticking effects and reduce the efforts.

Finally, referring to FIG. 6, we will describe a third embodiment which may be considered as an evolution of the second embodiment that has just been described, this evolution leaning toward an optimization of some internal shapes of the cyclone separator.

Thus, in the upper region of the vertically movable inner body 12, the upper area 13 maintains a cylindrical general appearance, but it exhibits a slightly frustoconical shape, with a diameter that decreases downwards.

Over the whole of its lower half, the tubular portion 14 of the vertically movable inner body 12 exhibits a flared shape, until the lower end 15. The fixed central element 19 exhibits a frustoconical shape, with two areas with different tapers which confer a curved appearance profile thereto.

Thanks to such shapes, when the inner body 12 moves vertically, the passage sections of the gases vary in a non linear way depending on the displacement, the section variations being made quicker at the locations where the pressure drops are the most significant, these locations themselves varying depending on the position of the inner body 12. The pressure drop variations may thus be best compensated in order to remain constant.

The cyclone separator, described above in various embodiments, may be applied in particular in the oil-gas separation in an internal combustion engine, in particular for the recovery of oil particles contained in the recycled crankcase gases, the cyclone separator being, in this application case, housed under the cylinder head cover of the engine.

It goes without saying that the invention is not limited only to the embodiments of this cyclone separator which have been described above, by way of example; it encompasses, on the contrary, all the alternative embodiments and applications complying with the same principle, in particular regardless of the shape details of the cyclone portion and the vertically movable inner body, and regardless of the nature of the fluids or other materials processed by the separator. Are also considered within the scope of the invention all additional arrangements, such as the addition of abutments limiting the vertical stroke or the radial clearance of the inner body and/or damping the arrival at the end of stroke of this inner body.

1. A cyclone separator, in particular provided for the oil-gas separation and more particularly provided for the separation and the recovery of the oil particles contained in the recycled crankcase gases, in an internal combustion engine of a motor vehicle,
the cyclone separator including, from top to bottom:
a tangential upper inlet of the gases containing particles and in particular oil drops to be eliminated,
a cylindrical area of catchment of particles and in particular of liquid oil, and
a lower area of storage of the phase, such as the oil, which has been separated,
while an axial outlet of the gases is provided,
the cyclone separator further including an outer body having a generally cylindrical shape with a flat bottom, without a conical lower area,
wherein an inner body is movably mounted vertically in the outer body, the inner body being rotationally symmetrical recessed and cooperating with the opening of the tangential upper inlet of the gases and/or with the start of the axial outlet of the gases, so as to make the passage section of the gases variable according to the height position of said inner body.

2. The cyclone separator according to claim 1, wherein the inner body has an upper area having a cylindrical appearance, capable of more or less hiding the opening of the tangential upper inlet of the gases, according to the height position of said inner body.

3. The cyclone separator according to claim 2, wherein said upper area of the inner body has a slightly frustoconical shape, with a diameter decreasing downwards.

4. The cyclone separator according to claim 2, wherein the upper area of the inner body is extended, downwards, by a tubular portion of this inner body which itself constitutes the start of the axial outlet of the gases.

5. The cyclone separator according to claim 1, wherein the lower portion of the inner body is provided to cooperate with a fixed central element mounted inside the cyclone separator, so as to vary the passage section at the start of the axial outlet of the gases according to the height position of said inner body.

6. The cyclone separator according to claim 5, wherein the lower portion of the inner body exhibits a flared shape and cooperates with a fixed central element having a conical or frustoconical appearance.

7. The cyclone separator according to claim 5, wherein the fixed central element has a foot fixed on the flat bottom of the outer body.

8. The cyclone separator according to claim 1, wherein spring means are provided to bias the inner body downwards.

9. The cyclone separator according to claim 1, wherein at least one gasket is placed between the inner body and the outer body.

10. The cyclone separator according to claim 2, wherein the gasket is placed at the upper area of the inner body.

11. The cyclone separator according to claim 10, wherein the gasket bears on a frustoconical surface of the outer body.
